(19) United States
(12) Patent Application Publication
(10) Pub. No.: US 2018/0243976 A1
(43) Pub. Date: Aug. 30, 2018

(54) Method and Apparatus for Producing Three- Dimensional Objects

(71) Applicant: Carbon, Inc., Redwood City, CA (US)

(72) Inventor: Bob E. Feller, Mountain View, CA (US)

(21) Appl. No.: 15/754,153

(22) PCT Filed: Sep. 29, 2016
(86) PCT No.: PCT/US2016/054467

§ 371 Date: Feb. 21, 2018

Related U.S. Application Data
(60) Provisional application No. 62/235,159, filed on Sep. 30, 2015.

(51) Int. Cl. B29C 64/129; B29C 64/282

(52) U.S. Cl. CPC B29C 64/129; B33Y 10/00; B29C 64/282

(57) ABSTRACT

A method of forming a three-dimensional object is carried out by: (a) providing a carrier and an optically transparent member having a build surface, the carrier and the build surface defining a build region therebetween; (b) filling the build region with a polymerizable liquid, (c) irradiating the build region with light through the optically transparent member and also advancing the carrier away from the build surface to form a three-dimensional solidified polymer object from the polymerizable liquid. The irradiating is carried out with both: (i) an excitation light at a first wavelength that polymerizes the polymerizable liquid, and (ii) a depletion light at a second wavelength, different from the first wavelength, that inhibits the polymerization of the polymerizable liquid. At least one of the excitation and depletion lights is temporally and/or spatially modulated to form the three-dimensional object.

### RELATED APPLICATIONS

This application claims the benefit of U.S. Provisional Patent Application Ser. No. 62/235,159, filed Sep. 30, 2015, the disclosure of which is incorporated by reference herein in its entirety.

### FIELD OF THE INVENTION

The present invention concerns materials, methods and apparatus for the fabrication of solid three-dimensional objects from liquid materials, and objects so produced.

### BACKGROUND OF THE INVENTION

In conventional additive or three-dimensional fabrication techniques, construction of a three-dimensional object is performed in a step-wise or layer-by-layer manner. In particular, layer formation is performed through solidification of photo curable resin under the action of visible or UV light irradiation. Two techniques are known: one in which new layers are formed at the top surface of the growing object; the other in which new layers are formed at the bottom surface of the growing object.

If new layers are formed at the top surface of the growing object, then after each irradiation step the object under construction is lowered into the resin “pool,” a new layer of resin is coated on top, and a new irradiation step takes place. An early example of such a technique is given in Hull, U.S. Pat. No. 5,236,637, at FIG. 3. A disadvantage of such “top down” techniques is the need to submerge the growing object in a (potentially deep) pool of liquid resin and reconstitute a precise overlayer of liquid resin.

If new layers are formed at the bottom of the growing object, then after each irradiation step the object under construction must be separated from the bottom plate in the fabrication well. An early example of such a technique is given in Hull, U.S. Pat. No. 5,236,637, at FIG. 4. While such “bottom up” techniques hold the potential to eliminate the need for a deep well in which the object is submerged by instead lifting the object out of a relatively shallow well or pool, a problem with such “bottom up” fabrication techniques, as commercially implemented, is that extreme care must be taken, and additional mechanical elements employed, when separating the solidified layer from the bottom plate due to physical and chemical interactions therebetween. For example, in U.S. Pat. No. 7,438,846, an elastic separation layer is used to achieve “non-destructive” separation of solidified material at the bottom construction plane. Other approaches, such as the B9Creator™ 3-dimensional printer marketed by B9Creations of Deadwood, S. Dak., USA, employ a sliding build plate. See, e.g., M. Joyce, US Patent App. 2013/0292862 and Y. Chen et al., US Patent App. 2013/0295212 (both Nov. 7, 2013); see also Y. Pan et al., J Manufacturing Sci. and Eng. 134, 051011-1 (October 2012). Such approaches introduce a mechanical step that may complicate the apparatus, slow the method, and/or potentially distort the end product.

Continuous processes for producing a three-dimensional object are suggested at some length with respect to “top down” techniques in U.S. Pat. No. 7,892,474, but this reference does not explain how they may be implemented in “bottom up” systems in a manner non-destructive to the article being produced, which limits the materials which can be used in the process, and in turn limits the structural properties of the objects so produced.

### SUMMARY OF THE INVENTION

The present invention provides a method of forming a three-dimensional object, which may be carried out by:

(a) providing a carrier and an optically transparent member having a build surface, the carrier and the build surface defining a build region therebetween;

(b) filling the build region with a polymerizable liquid,

(c) irradiating the build region with light through the optically transparent member and also advancing the carrier away from the build surface to form a three-dimensional solidified polymer object from the polymerizable liquid,

wherein the irradiating is carried out with both: (i) an excitation light at a first wavelength that polymerizes the polymerizable liquid, and (ii) a depletion light at a second wavelength, different from the first wavelength, that inhibits the polymerization of the polymerizable liquid.

Typically, at least one of the excitation and depletion lights is temporally and/or spatially modulated (and preferably both temporally and spatially modulated) to thereby form the three-dimensional object.

Apparatus for carrying out methods of the invention is also described.

Non-limiting examples and specific embodiments of the present invention are explained in greater detail in the drawings herein and the specification set forth below. The disclosures of all United States Patent references cited herein are to be incorporated herein by reference in their entirety.

### BRIEF DESCRIPTION OF THE DRAWINGS

FIG. 1 is a schematic illustration of one set of embodiments of apparatus and methods of the present invention.

FIG. 2 is a schematic illustration of an addition set of embodiments of apparatus and methods of the present invention.

FIGS. 3A-3B schematically illustrates a single wavelength exposure pattern, and corresponding segment of the growing three dimensional object, of prior bottom-up three dimensional fabrication techniques. In FIGS. 3A, 4A, 5A, and 6A, vertical stripes identify pixels delivering excitation wavelength exposure; bold diagonal stripes identify pixels delivering high intensity depletion wavelength exposure; and light diagonal stripes identify pixels delivering low intensity depletion wavelength exposure. In FIGS. 3B, 4B, 5B, and 6B, white squares identify regions, corresponding to pixels, in segment of the produced part corresponding to the slice of pixels on the left that are not polymerized, and black squares identify regions that are polymerized.

FIG. 4A-4B schematically illustrates a first example embodiment of a dual wavelength exposure pattern of the present invention, in which intensity of the depletion light is uniformly delivered.

FIG. 5A-5B schematically illustrates a second example embodiment of a dual wavelength exposure pattern of the present invention, in which intensity of the depletion light is non-uniformly delivered, in a concentric pattern.

FIG. 6A-6B schematically illustrates a second example embodiment of a dual wavelength exposure pattern of the present invention, in which intensity of the depletion light is non-uniformly delivered, in an offset pattern.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

“Shape to be imparted to” refers to the case where the shape of the intermediate object slightly changes between formation thereof and forming the subsequent three-dimensional product, typically by shrinkage (e.g., up to 1, 2 or 4 percent by volume), expansion (e.g., up to 1, 2 or 4 percent by volume), removal of support structures, or by intervening forming steps (e.g., intentional bending, stretching, drilling, grinding, cutting, polishing, or other intentional forming after formation of the intermediate product, but before formation of the subsequent three-dimensional product).

### I. Polymerizable Liquids.

Dual cure systems as described herein may include a first curable system (sometimes referred to as “Part A” or herein) that is curable by actinic radiation, typically light, and in some embodiments ultraviolet (UV) light). Any suitable polymerizable liquid can be used as the first component. The liquid (sometimes also referred to as “liquid resin” “ink,” or simply “resin” herein) can include a monomer, particularly photopolymerizable and/or free radical polymerizable monomers, and a suitable initiator such as a free radical initiator, and combinations thereof. Examples include, but are not limited to, acrylics, methacrylics, acrylamides, styrenics, olefins, halogenated olefins, cyclic alkenes, maleic anhydride, alkenes, alkynes, carbon monoxide, functionalized oligomers, multifunctional cute site monomers, functionalized PEGs, etc., including combinations thereof. Examples of liquid resins, monomers and initiators include but are not limited to those set forth in U.S. Pat. Nos. 8,232,043; 8,119,214; 7,935,476; 7,767,728; 7,649,029; WO 2012129968 A1; CN 102715751 A; JP 2012210408 A.

Acid Catalyzed Polymerizable Liquids.

While in some embodiments as noted above the polymerizable liquid comprises a free radical polymerizable liquid (in which case an inhibitor may be oxygen as described below), in other embodiments the polymerizable liquid comprises an acid catalyzed, or cationically polymerized, polymerizable liquid. In such embodiments the polymerizable liquid comprises monomers contain groups suitable for acid catalysis, such as epoxide groups, vinyl ether groups, etc. Thus suitable monomers include olefins such as methoxyethene, 4-methoxystyrene, styrene, 2-methylprop-1-ene, 1,3-butadiene, etc.; heterocycloic monomers (including lactones, lactams, and cyclic amines) such as oxirane, thietane, tetrahydrofuran, oxazoline, 1,3, dioxepane, oxetan-2-one, etc., and combinations thereof. A suitable (generally ionic or non-ionic) photoacid generator (PAG) is included in the acid catalyzed polymerizable liquid, examples of which include, but are not limited to onium salts, sulfonium and iodonium salts, etc., such as diphenyl iodide hexafluorophosphate, diphenyl iodide hexafluoroarsenate, diphenyl iodide hexafluoroantimonate, diphenyl p-methoxyphenyl triflate, diphenyl p-toluenyl triflate, diphenyl p-isobutylphenyl triflate, diphenyl p-tert-butylphenyl triflate, triphenylsulfonium hexafluororphosphate, triphenylsulfonium hexafluoroarsenate, triphenylsulfonium hexafluoroantimonate, triphenylsulfonium triflate, dibutylnaphthylsulfonium triflate, etc., including mixtures thereof. See, e.g., U.S. Pat. Nos. 7,824,839; 7,550,246; 7,534,844; 6,692,891; 5,374,500; and 5,017,461; see also Photoacid Generator Selection Guide for the electronics industry and energy curable coatings (BASF 2010).

Hydrogels. In some embodiments suitable resins includes photocurable hydrogels like poly(ethylene glycols) (PEG) and gelatins. PEG hydrogels have been used to deliver a variety of biologicals, including Growth factors; however, a great challenge facing PEG hydrogels crosslinked by chain growth polymerizations is the potential for irreversible protein damage. Conditions to maximize release of the biologicals from photopolymerized PEG diacrylate hydrogels can be enhanced by inclusion of affinity binding peptide sequences in the monomer resin solutions, prior to photopolymerization allowing sustained delivery. Gelatin is a biopolymer frequently used in food, cosmetic, pharmaceutical and photographic industries. It is obtained by thermal denaturation or chemical and physical degradation of collagen. There are three kinds of gelatin, including those found in animals, fish and humans. Gelatin from the skin of cold water fish is considered safe to use in pharmaceutical applications. UV or visible light can be used to crosslink appropriately modified gelatin. Methods for crosslinking gelatin include cure derivatives from dyes such as Rose Bengal.

Photocurable Silicone Resins.

A suitable resin includes photocurable silicones. UV cure silicone rubber, such as Siliopren™ UV Cure Silicone Rubber can be used as can LOCTITE™ Cure Silicone adhesives sealants. Applications include optical instruments, medical and surgical equipment, exterior lighting and enclosures, electrical connectors/sensors, fiber optics and gaskets.

Biodegradable Resins.

Biodegradable resins are particularly important for implantable devices to deliver drugs or for temporary performance applications, like biodegradable screws and stents (U.S. Pat. Nos. 7,919,162; 6,932,930). Biodegradable copolymers of lactic acid and glycolic acid (PLGA) can be dissolved in PEG dimethacrylate to yield a transparent resin suitable for use. Polycaprolactone and PLGA oligomers can be functionalized with acrylic or methacrylic groups to allow them to be effective resins for use.

Photocurable Polyurethanes.

A particularly useful resin is photocurable polyurethanes (including, polyureas, and copolymers of polyurethanes and polyureas (e.g., poly(urethane-urea)). A photopolymerizable polyurethane/polyurea composition comprising (1) a polyurethane based on an aliphatic diisocyanate, poly(hexamethylene isophthalate glycol) and, optionally, 1,4-butanediol; (2) a polyfunctional acrylic ester; (3) a photoinitiator; and (4) an anti-oxidant, can be formulated so that it provides a hard, abrasion-resistant, and stain-resistant material (U.S. Pat. No. 4,337,130). Photocurable thermoplastic polyurethane elastomers incorporate photoreactive diacetylene diols as chain extenders.

High Performance Resins.

In some embodiments, high performance resins are used. Such high performance resins may sometimes require the use of heating to melt and/or reduce the viscosity thereof, as noted above and discussed further below. Examples of such resins include, but are not limited to, resins for those materials sometimes referred to as liquid crystalline polymers of esters, ester-imide, and ester-amide oligomers, as described in U.S. Pat. Nos. 7,507,784; 6,939,940. Since such resins are sometimes employed as high-temperature thermoset resins, in the present invention they further comprise a suitable photoinitiator such as benzophenone, anthraquinone, and fluoroenone initiators (including derivatives thereof), to initiate cross-linking on irradiation, as discussed further below.

Additional Example Resins.

Particularly useful resins for dental applications include EnvisionTEC's Clear Guide, EnvisionTEC's E-Denstone Material. Particularly useful resins for hearing aid industries include EnvisionTEC's e-Shell 300 Series of resins. Particularly useful resins include EnvisionTEC's HTM140IV High Temperature Mold Material for use directly with vulcanized rubber in molding/casting applications. A particularly useful material for making tough and stiff parts includes EnvisionTEC's RC31 resin. Particularly useful resin for investment casting applications include EnvisionTEC's Easy Cast EC500 resin and MadeSolid FireCast resin.

Additional Resin Ingredients.

The liquid resin or polymerizable material can have solid particles suspended or dispersed therein. Any suitable solid particle can be used, depending upon the end product being fabricated. The particles can be metallic, organic/polymeric, inorganic, or composites or mixtures thereof. The particles can be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. The particles can be of any suitable size (for example, ranging from 1 nm to 20 um average diameter).

The particles can comprise an active agent or detectable compound as described below, though these may also be provided dissolved solubilized in the liquid resin as also discussed below. For example, magnetic or paramagnetic particles or nanoparticles can be employed.

The liquid resin can have additional ingredients solubilized therein, including pigments, dyes, active compounds or pharmaceutical compounds, detectable compounds (e.g., fluorescent, phosphorescent, radioactive), etc., again depending upon the particular purpose of the product being fabricated. Examples of such additional ingredients include, but are not limited to, proteins, peptides, nucleic acids (DNA, RNA) such as siRNA, sugars, small organic compounds (drugs and drug-like compounds), etc., including combinations thereof.

Non-Reactive Light Absorbers.

In some embodiments, polymerizable liquids for carrying out the present invention include a non-reactive pigment or dye that absorbs light, particularly UV light. Suitable examples of such light absorbers include, but are not limited to: (i) titanium dioxide (e.g., included in an amount of from 0.05 or 0.1 to 1 or 5 percent by weight), (ii) carbon black (e.g., included in an amount of from 0.05 or 0.1 to 1 or 5 percent by weight), and/or (iii) an organic ultraviolet light absorber such as a hydroxybenzophenone, hydroxyphenylbenzotriazole, oxanilide, benzophenone, hydroxypenyltriazine, and/or benzotriazole ultraviolet light absorber (e.g., Mayzo BLS1326) (e.g., included in an amount of 0.001 or 0.005 to 1, 2 or 4 percent by weight). Examples of suitable organic ultraviolet light absorbers include, but are not limited to, those described in U.S. Pat. Nos. 3,213,058; 6,916,867; 7,157,586; and 7,695, 643, the disclosures of which are incorporated herein by reference.

Inhibitors of Polymerization.

Inhibitors or polymerization inhibitors for use in the present invention may be in the form of a liquid or a gas. In some embodiments, gas inhibitors are preferred. The specific inhibitor will depend upon the monomer being polymerized and the polymerization reaction. For free radical polymerization monomers, the inhibitor can conveniently be oxygen, which can be provided in the form of a gas such as air, a gas enriched in oxygen (optionally but in some embodiments preferably containing additional inert gases to reduce combustibility thereof), or in some embodiments pure oxygen gas. In alternate embodiments, such as where the monomer is polymerized by photoacid generator initiator, the inhibitor can be a base such as ammonia, trace amines (e.g. methyl amine, ethyl amine, di and trialkyl amines such as dimethyl amine, diethyl amine, trimethyl amine, triethyl amine, etc.), or carbon dioxide, including mixtures or combinations thereof.

Polymerizable Liquids Carrying Live Cells.

In some embodiments, the polymerizable liquid may carry live cells as “particles” therein. Such polymerizable liquids are generally aqueous, and may be oxygenated, and may be considered as “emulsions” where the live cells are the discrete phase. Suitable live cells may be plant cells (e.g., monocot, dicot), animal cells (e.g., mammalian, avian, amphibian, reptile cells), microbial cells (e.g., prokaryote, eukaryote, protozoal, etc.), etc. The cells may be of differentiated cells from or corresponding to any type of tissue (e.g., blood, cartilage, bone, muscle, endocrine gland, exocrine gland, epithelial, endothelial, etc.), or may be undifferentiated cells such as stem cells or progenitor cells. In such embodiments the polymerizable liquid can be one that forms a hydrogel, including but not limited to those described in U.S. Pat. Nos. 7,651,683; 7,651,682; 7,556,490; 6,602,975; 5,836,313; etc.

Pigments or Dyes.

In some embodiments, polymerizable liquids used in the present invention include a non-reactive pigment or dye. Examples include, but are not limited to, (i) titanium dioxide (e.g., in an amount of from 0.05 or 0.1 to 1 or 5 percent by weight), (ii) carbon black (e.g., included in an amount of from 0.05 or 0.1 to 1 or 5 percent by weight), and/or (iii) an organic ultraviolet light absorber such as a hydroxybenzophenone, hydroxyphenylbenzotriazole, oxanilide, benzophenone, hydroxypenyltriazine, and/or benzotriazole ultraviolet light absorber (e.g. in an amount of 0.001 or 0.005 to 1, 2 or 4 percent by weight).

### II. Methods and Apparatus.

Some elements, steps and features that may be used in carrying out the present invention are explained in PCT Applications Nos. PCT/US2014/015486 (also published as US 2015/0102532); PCT/US2014/015506 (also published as US 2015/0097315), PCT/US2014/015497 (also published as US 2015/0097316), and in J. Tumbleston, D. Shirvanyants, N. Ermoshkin et al., Continuous liquid interface production of 3D Objects, Science 347, 1349-1352 (published online 16 Mar. 2015).

Additional elements, steps and features that may be used in carrying out the present invention are explained in US Patent Application Publication No. US 2004/0181313 to Shih et al., in U.S. Pat. No. 8,697,346 to McLeod et al., S. Hell et al., Nanoscale Resolution with Focused Light: STED and Other RESOLFT Microscopy Concepts, in Handbook of Biological Confocal Microscopy (J. Pawley ed., 3d Ed. 2006); T. Andrew et al., Confining Light to Deep Subwavelength Dimensions to Enable Optical Nanopatterning, Science, 324, 917-921 (2009); and T. Scott et al., Two-color Single-Photon Photoinitiation and Photoinhibition for subdiffraction Photolithography, Science 324, 913-917 (2009).

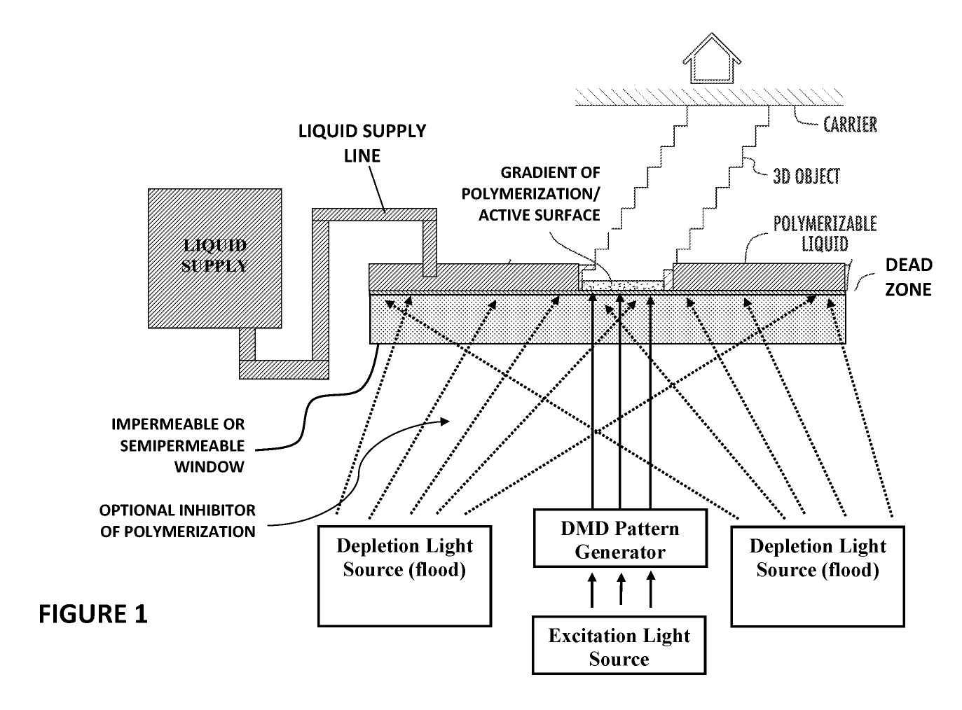

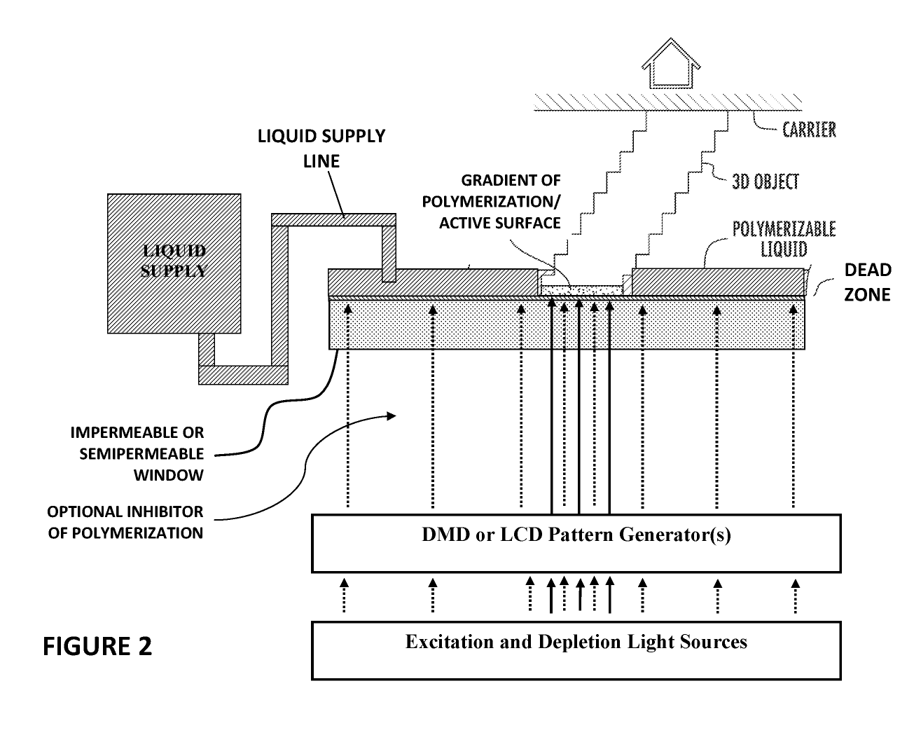

As schematically illustrated in FIGS. 1-2, an apparatus for forming a three-dimensional object by the methods of the invention may generally include:

(a) a carrier;

(b) an optically transparent member having a build surface, the carrier and the build surface defining a build region therebetween;

(c) a polymerizable liquid supply operatively associated with the build surface;

(d) a first light source operatively associated with the optically transparent member and configured to deliver excitation light to the build region at a first wavelength that polymerizes the polymerizable liquid,

(e) a second light source operatively associated with the optically transparent member and configured to deliver depletion light at a second wavelength, different from the first wavelength, that inhibits the polymerization of the polymerizable liquid; and

(f) a pattern generator operatively associated with at least one of the first and second light sources.

In some embodiments, the optically transparent member is impermeable to an inhibitor of polymerization. For example, it may consist or consist essentially of a single unitary sheet of glass, quartz, or sapphire, typically carried by a support frame (aka, a “window frame”).

In other embodiments, the optically transparent member may be permeable to an inhibitor of polymerization (such as atmospheric oxygen). In this case, it may comprise a fluoropolymer film or sheet, which contacts the polymerizable liquid, and which has appropriate feed surfaces for feeding the inhibitor therethrough. Where the sheet is flexible, it may be provided with an optically transparent underlying support, and/or tensioned, in accordance with known techniques.

Any suitable light source may be used for either of the two light sources, including LEDs and mercury lamp lights, optionally with appropriate filters. The light sources may be configured in association with a pattern generator, or in the case of a flood light may provide direct illumination to the build region (see FIG. 1).

In some embodiments, the pattern generator comprises a liquid crystal display (LCD). In other embodiments, the pattern generator may be a digital micromirror display (DMD) (also referred to as a digital micromirror array, or DMA).

Polymerizable liquid supply may be provided in any suitable manner, such as by a separate reservoir and associated siphon tube as shown, a simple well over the build surface to contain a pool of polymerizable liquid, pumping and mixing systems, etc., including combinations thereof.

Suitable control may be provided through hardware and/or software, not shown, in accordance with equipment, software, and techniques known in the art, or variations thereof that will be apparent to those skilled in the art.

In use, as noted above, the methods may be carried out by:

filling the build region with a polymerizable liquid,

and irradiating the build region with light through the optically transparent member;

and also advancing the carrier away from the build surface to form a three-dimensional solidified polymer object from the polymerizable liquid.

In the present invention, the irradiating is carried out with both: (i) an excitation light at a first wavelength that polymerizes the polymerizable liquid, and (ii) a depletion light at a second wavelength, different from the first wavelength, that inhibits the polymerization of the polymerizable liquid.

In some embodiments, the excitation light is both spatially and temporally modulated, and the depletion light is: (i) uniform flood exposure over time, (ii) uniform flood exposure modulated in intensity over time; (iii) uniform intensity exposure spatially modulated over time; or (iv) spatially and temporally modulated over time.

In other embodiments, the excitation light is (i) uniform flood exposure over time or (ii) uniform flood exposure modulated in intensity over time, and the depletion light is both spatially and temporally modulated.

Preferably, the depletion light, alone or in combination with an inhibitor of polymerization, maintains a sustained release layer of non-polymerized polymerizable liquid on the build surface, contacting the active surface or gradient of polymerization zone of the growing three-dimensional object, during, some of, a major portion of, or all of the time of the fabrication of the growing three-dimensional object being produced. Thus, in some embodiments, the irradiating and/or the advancing steps are carried out while also concurrently: (i) continuously maintaining a dead zone of polymerizable liquid in contact with the build surface, and (ii) continuously maintaining a gradient of polymerization zone or active surface between the dead zone and the solidified polymer and in contact with each thereof, the gradient of polymerization zone or active surface comprising the polymerizable liquid in partially cured form.

Thus, the dead zone can be maintained by (a) exposure of the polymerizable liquid to the second light, (b) feeding of the inhibitor of polymerization through the optically transparent member, or (c) a combination thereof.

In some embodiments, the polymerizable liquid contains at least one dye that absorbs light at the excitation wavelength. In some embodiments, the polymerizable liquid contains at least one dye that absorbs light at the depletion wavelength. The dyes may be the same dye, or different, depending on factors such as the absorption spectra of the dye, the intensity of each respective light, etc.

Irradiating with the excitation light can be carried out continuously, intermittently, or a combination thereof.

Similarly, irradiating with the depletion light may be carried out continuously, intermittently, or a combination thereof.

Advancing of the carrier may be carried out continuously, intermittently (e.g., in step-wise fashion), reciprocally, or as combination thereof (e.g., a continuous phase to produce a relatively small or uniform segment of the three-dimensional object, a reciprocal phase to produce a relatively large or dense segment of the three-dimensional object, etc.)

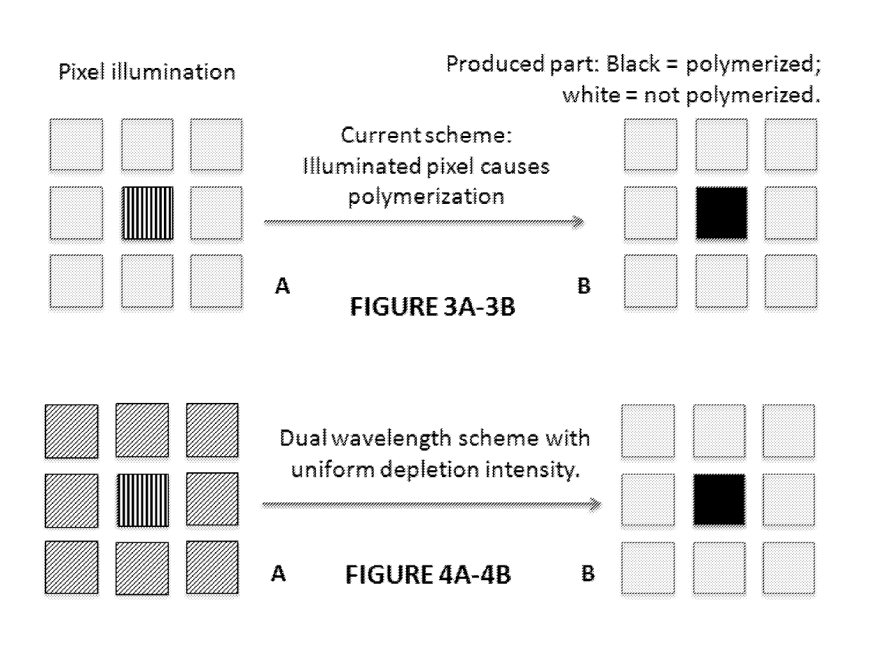

Additional aspects of the invention are explained in FIGS. 3A-6B. In FIGS. 3A, 4A, 5A, and 6A, vertical stripes identify pixels delivering excitation wavelength exposure; bold diagonal stripes identify pixels delivering high intensity depletion wavelength exposure; and light diagonal stripes identify pixels delivering low intensity depletion wavelength exposure. In FIGS. 3B, 4B, 5B, and 6B, white squares identify regions, corresponding to pixels, in segment of the produced part corresponding to the slice of pixels on the left that are not polymerized, and black squares identify regions that are polymerized.

FIGS. 3A-3B illustrate currently known exposure techniques, in which a single pixel is illuminated with excitation light, and the corresponding region in the growing three-dimensional object is polymerized.

FIGS. 4A-4B schematically illustrates an embodiment of a dual wavelength scheme, in which (i) the depletion intensity is relatively low, and uniform throughout (including under the vertical striped spot representing the center pixel for exposure) to create dead zone. Vertical stripes identify pixels delivering an excitation wavelength exposure, and light diagonal stripes identify pixels delivering a low intensity depletion wavelength exposure. Where, as in FIG. 4b, a pixel receives both exposures, only the excitation exposure is identified by illustration.

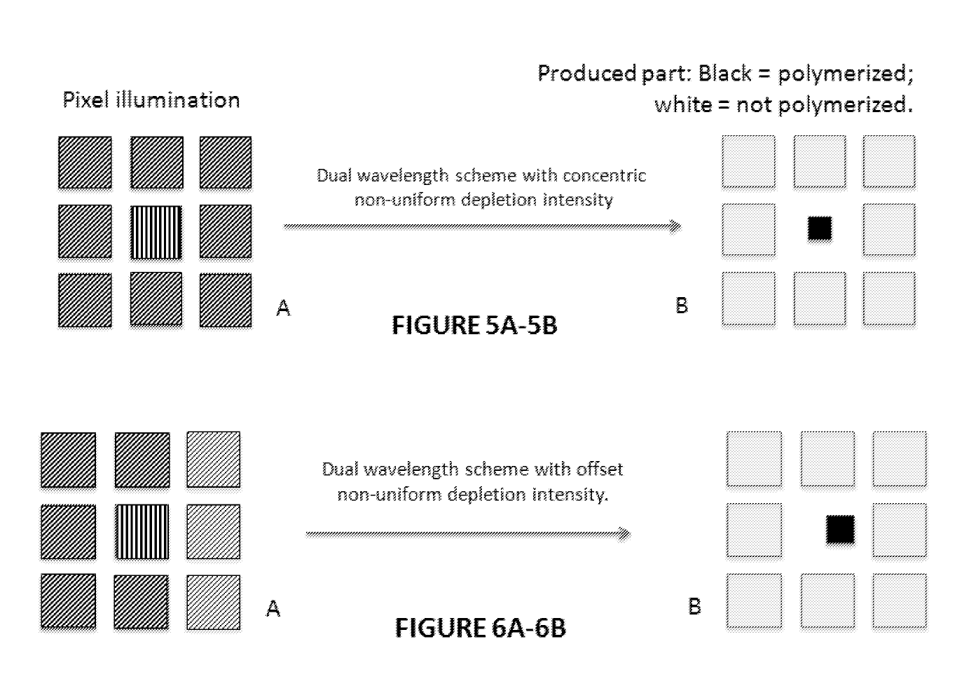

FIGS. 5A-5B schematically illustrate a second embodiment of a dual wavelength scheme, in which, in which (i) the overall depletion intensity is relatively high, but is not uniform (is spatially modulated). Specifically, the center pixel receives low intensity depletion light (not shown), as in FIG. 4A, while the surrounding eight pixels receive higher intensity depletion light. There is some optical overlap between the pixels (e.g., achieved by slight defocusing). The polymerized size of the feature or segment of the object polymerized by the center pixel is smaller, due to the depletion beam spilling over into excitation beam, yet remains centered in the horizontal dimension of the object, relative to the pixels delivering light, because of the equal intensity of the depletion light delivered in the surrounding pixels.

FIGS. 6A-6B schematically illustrate a third embodiment of a dual wavelength scheme, in which (i) the depletion intensity is both high and low (spatially modulated). Specifically, the center pixel, and the pixels on the right, receive low intensity depletion light, while the pixels to the left, and above and below the center pixel, receive higher intensity depletion light. Again there is some optical overlap between the pixels (e.g., achieved by slight defocusing). The polymerized size of the feature or segment of the object polymerized by the center pixel is smaller and shifted to the right, due to the depletion beam spilling over in an unequal or offset manner into the excitation beam.

While the dead zone and the gradient of polymerization zone do not have a strict boundary therebetween (in those locations where the two meet), the thickness of the gradient of polymerization zone is in some embodiments at least as great as the thickness of the dead zone. Thus, in some embodiments, the dead zone has a thickness of from 0.01, 0.1, 1, 2, or 10 microns up to 100, 200 or 400 microns, or more, and/or the gradient of polymerization zone and the dead zone together have a thickness of from 1 or 2 microns up to 400, 600, or 1000 microns, or more. Thus the gradient of polymerization zone may be thick or thin depending on the particular process conditions at that time. Where the gradient of polymerization zone is thin, it may also be described as an active surface on the bottom of the growing three-dimensional object, with which monomers can react and continue to form growing polymer chains therewith. In some embodiments, the gradient of polymerization zone, or active surface, is maintained (while polymerizing steps continue) for a time of at least 5, 10, 15, 20 or 30 seconds, up to 5, 10, 15 or 20 minutes or more, or until completion of the three-dimensional product.

The method may further comprise the step of disrupting the gradient of polymerization zone for a time sufficient to form a cleavage line in the three-dimensional object (e.g., at a predetermined desired location for intentional cleavage, or at a location in the object where prevention of cleavage or reduction of cleavage is non-critical), and then reinstating the gradient of polymerization zone (e.g. by pausing, and resuming, the advancing step, increasing, then decreasing, the intensity of irradiation, and combinations thereof).

In some embodiments, the advancing step is carried out sequentially in uniform increments (e.g., of from 0.1 or 1 microns, up to 10 or 100 microns, or more) for each step or increment. In some embodiments, the advancing step is carried out sequentially in variable increments (e.g., each increment ranging from 0.1 or 1 microns, up to 10 or 100 microns, or more) for each step or increment. The size of the increment, along with the rate of advancing, will depend in part upon factors such as temperature, pressure, structure of the article being produced (e.g., size, density, complexity, configuration, etc.)

In other embodiments of the invention, the advancing step is carried out continuously, at a uniform or variable rate.

In some embodiments, the rate of advance (whether carried out sequentially or continuously) is from about 0.11, or 10 microns per second, up to about to 100, 1,000, or 10,000 microns per second, again depending again depending on factors such as temperature, pressure, structure of the article being produced, intensity of radiation, etc.

When the patterned irradiation is a variable pattern rather than a pattern that is held constant over time, then each irradiating step may be any suitable time or duration depending on factors such as the intensity of the irradiation, the presence or absence of dyes in the polymerizable material, the rate of growth, etc. Thus in some embodiments each irradiating step can be from 0.001, 0.01, 0.1, 1 or 10 microseconds, up to 1, 10, or 100 minutes, or more, in duration. The interval between each irradiating step is in some embodiments preferably as brief as possible, e.g., from 0.001, 0.01, 0.1, or 1 microseconds up to 0.1, 1, or 10 seconds. In example embodiments, the pattern may vary hundreds, thousands or millions of times to impart shape changes on the three-dimensional object being formed. In addition, in example embodiments, the pattern generator may have high resolution with millions of pixel elements that can be varied to change the shape that is imparted. For example, the pattern generator may be a DLP with more than 1,000 or 2,000 or 3,000 or more rows and/or more than 1,000 or 2,000 or 3,000 or more columns of micromirrors, or pixels in a liquid crystal display panel, that can be used to vary the shape. In example embodiments, the three-dimensional object may be formed through the gradient of polymerization allowing the shape changes to be imparted while continuously printing. In example embodiments, this allows complex three-dimensional objects to be formed at high speed with a substantially continuous surface without cleavage lines or seams. In some examples, thousands or millions of shape variations may be imparted on the three-dimensional object being formed without cleavage lines or seams across a length of the object being formed of more than 1 mm, 1 cm, 10 cm or more or across the entire length of the formed object. In example embodiments, the object may be continuously formed through the gradient of polymerization at a rate of more than 1, 10, 100, 1000, 10000 or more microns per second.

### III. Objects Produced.

The above methods, structures, materials, compositions and properties may be used to produce a virtually unlimited number of products. Examples include, but are not limited to, medical devices and implantable medical devices such as stents, drug delivery depots, catheters, bladder, breast implants, testicle implants, pectoral implants, eye implants, contact lenses, dental aligners, microfluidics, seals, shrouds, and other applications requiring high biocompatibility, functional structures, microneedle arrays, fibers, rods, waveguides, micromechanical devices, microfluidic devices; fasteners; electronic device housings; gears, propellers, and impellers; wheels, mechanical device housings; tools; structural elements; hinges including living hinges; boat and watercraft hulls and decks; wheels; bottles, jars and other containers; pipes, liquid tubes and connectors; foot-ware soles, heels, innersoles and midsoles; bushings, o-rings and gaskets; shock absorbers, funnel/hose assembly, cushions; electronic device housings; shin guards, athletic cups, knee pads, elbow pads, foam liners, padding or inserts, helmets, helmet straps, head gear, shoe cleats, gloves, other wearable or athletic equipment, brushes, combs, rings, jewelry, buttons, snaps, fasteners, watch bands or watch housings, mobile phone or tablet casings or housings, computer keyboards or keyboard buttons or components, remote control buttons or components, auto dashboard components, buttons, dials, auto body parts, paneling, other automotive, aircraft or boat parts, cookware, bakeware, kitchen utensils, steamers and any number of other 3D objects. The universe of useful 3D products that may be formed is greatly expanded by the ability to impart a wide range of shapes and properties, including elastomeric properties, through the use of multiple methods of hardening such as dual cure where a shape can be locked-in using continuous liquid interphase printing and subsequent thermal or other curing can be used to provide elastomeric or other desired properties. Any of the above described structures, materials and properties can be combined to form 3D objects including the 3D formed products described above. These are examples only and any number of other 3D objects can be formed using the methods and materials described herein.

### Example

An example of aspects of the present invention is carried out by coating a glass window with a resin mixture of 10 grams of trimethylolpropane trimethacrylate (TMPTMA), 200 milligrams of camphorquinone, 200 milligrams of ethyl 4-(dimethylamino)benzoate (EDB), 100 milligrams of butyl nitrite, and 0 to 25 milligrams of BLS-1326, a benzotriazole ultraviolet light absorber (available from Mayzo, 3935 Lakefield Court, Suwanee, Ga., USA 30024).

The TMPTMA is the UV crosslinkable component. The camphorquinone and EDB are the initiator and amine co-initiator. Butyl nitrite is the photoinhibitor, and BLS-1326 is added to change the penetration depth of the inhibitor wavelength (approximately 10 milligrams can be used). Once the mixture is applied to the window, the window is flood exposed with light at an inhibition wavelength, and simultaneously exposed with light (e.g., patterned light) at the polymerization wavelength through any suitable light engine. The polymerization wavelength cab be 470 nanometers and inhibition wavelength can be 365 nanometers. The window can be illuminated with both be at an intensity of approximately 2 to 5 milliwatts per square centimeter. It is found that, with concurrent illumination with the inhibition light, the polymerized disc produced from the polymerization wavelength will slide on the glass window without adhering to the glass window.

The foregoing is illustrative of the present invention, and is not to be construed as limiting thereof. The invention is defined by the following claims, with equivalents of the claims to be included therein.

1. A method of forming a three-dimensional object, comprising:
(a) providing a carrier and an optically transparent member having a build surface, said carrier and said build surface defining a build region therebetween;
(b) filling said build region with a polymerizable liquid,
(c) irradiating said build region with light through said optically transparent member and also advancing said carrier away from said build surface to form a three-dimensional solidified polymer object from said polymerizable liquid,
wherein said irradiating is carried out with both: (i) an excitation light at a first wavelength that polymerizes said polymerizable liquid, and (ii) a depletion light at a second wavelength, different from said first wavelength, that inhibits the polymerization of said polymerizable liquid;
and wherein at least one of said excitation and depletion lights is temporally and/or spatially modulated to thereby form said three-dimensional object.

2. The method of claim 1, wherein:
said excitation light is both spatially and temporally modulated, and
said depletion light is: (i) uniform flood exposure over time, (ii) uniform flood exposure modulated in intensity over time; (iii) uniform intensity exposure spatially modulated over time; or (iv) spatially and temporally modulated over time.

3. The method of claim 1, wherein:
said excitation light is (i) uniform flood exposure over time or (ii) uniform flood exposure modulated in intensity over time, and
said depletion light is both spatially and temporally modulated.

4. The method of claim 1, wherein said optically transparent member is impermeable to an inhibitor of polymerization.

5. The method of claim 1, wherein said optically transparent member is permeable to an inhibitor of polymerization, and said method further comprises feeding an inhibitor of polymerization through said optically transparent member.

6. The method of claim 1, wherein said irradiating and/or said advancing steps are carried out while also concurrently:
(i) continuously maintaining a dead zone of polymerizable liquid in contact with said build surface, and
(ii) continuously maintaining a gradient of polymerization zone or active surface between said dead zone and said solidified polymer and in contact with each thereof, said gradient of polymerization zone or active surface comprising said polymerizable liquid in partially cured form.

7. The method of claim 6, wherein said dead zone is maintained by (a) exposure of said polymerizable liquid to said second light, (b) feeding of said inhibitor of polymerization through said optically transparent member, or (c) a combination thereof.

8. The method of claim 1, wherein said polymerizable liquid contains at least one dye that absorbs light at said excitation wavelength.

9. The method of claim 1, wherein said polymerizable liquid contains at least one dye that absorbs light at said depletion wavelength.

10. The method of claim 1, wherein said irradiating with an excitation light is carried out continuously, intermittently, or a combination thereof.

11. The method of claim 1, wherein said irradiating with a depletion light is carried out continuously, intermittently, or a combination thereof.

12. The method of claim 1, wherein said advancing is carried out continuously, intermittently, reciprocally, or a combination thereof.

13. The method of claim 1, wherein said patterned exposure is created by a liquid crystal display (LCD).

14. The method of claim 1, wherein said patterned exposure is created by a digital micromirror display (DMD).

15. An apparatus for forming a three-dimensional object, comprising:
(a) a carrier;
(b) an optically transparent member having a build surface, said carrier and said build surface defining a build region therebetween;
(c) a polymerizable liquid supply operatively associated with said build surface;
(d) a first light source operatively associated with said optically transparent member and configured to deliver excitation light to said build region at a first wavelength that polymerizes said polymerizable liquid,
(e) a second light source operatively associated with said optically transparent member and configured to deliver depletion light at a second wavelength, different from said first wavelength, that inhibits the polymerization of said polymerizable liquid; and
(f) a pattern generator operatively associated with at least one of said first and second light sources.

16. The apparatus of claim 15, wherein said optically transparent member is impermeable to an inhibitor of polymerization.

17. The apparatus of claim 15, wherein said optically transparent member is permeable to an inhibitor of polymerization.

18. The apparatus of claim 15, wherein said pattern generator comprises a liquid crystal display (LCD).

19. The apparatus of claim 15, wherein said pattern generator comprises a digital micromirror display (DMD).

20. The apparatus of claim 15, wherein said second light source is a flood light source.
